(19) United States
(12) Patent Application Publication
(10) Pub. No.: US 2006/0049811 A1
(43) Pub. Date: Mar. 9, 2006

(54) Output voltage ripple reduction technique for burst mode operation of power converter

(76) Inventor: Thomas Farkas, Marlborough, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/213,625

(22) Filed: Aug. 26, 2005

Related U.S. Application Data
(60) Provisional application No. 60/604,866, filed on Aug. 27, 2004.

(51) Int. Cl. G05F 1/56

(52) U.S. Cl. 323/268

(57) ABSTRACT

A power converter is controlled by a control circuit that includes a burst mode operation during low load conditions. A compensation circuit modifies a control signal to reduce the number of switch cycles during a burst. The compensation circuit includes a time-variant offset to the control signal that is removed when the power converter input signal is connected to low voltage.

### RELATED APPLICATION

This application claims the benefit of U.S. Provisional Application No. 60/604,866, filed on Aug. 27, 2004. The entire teachings of the above application are incorporated herein by reference.

### BACKGROUND

DC/DC power converters are often built using integrated control chips. These control chips direct the operation of other parts of the power converter, implementing some of the control features required to create a well-behaved circuit. However, many of the existing control chips do not always function properly, so that power converters built with these controllers do not behave as desired under certain conditions.

One type of control feature often implemented by control ICs is a means to reduce power consumption at light load conditions. These control means often employ burst-mode or discontinuous conduction mode operation. In general, this type of feature tends to increase the AC voltage ripple on the output of the power converter. Depending on the control method, this ripple can also be at a lower frequency than the normal operating frequency of the converter, requiring even more or larger energy storage elements at the output to filter the output ripple voltage.

### SUMMARY OF THE INVENTION

The addition of auxiliary circuitry can overcome defects and undesirable operation of power control ICs. Some control chips employ a burst-mode, or discontinuous conduction mode, to reduce power consumption at light load conditions. Ideally, the power switching devices are driven for a minimal duration “burst” and then held off for a period of time until the controller detects that the output voltage is beginning to sag. This minimal duration is preferably a single switching cycle, perhaps using the minimum duty cycle, or otherwise minimizing the amount of energy transferred to the output. If the control method or noise sensitivity causes the converter to operate for multiple cycles during each burst, the output voltage ripple can be many times larger than during normal operation.

Auxiliary circuitry may be added to force single-cycle operation in the burst mode. Where the controller employs an error amplifier to generate the PWM control signal that determines the timing and duration of the bursts, a non-linear or time-variant compensation may be employed by selectively injecting a signal into the error amplifier circuit to force the desired timing and duration.

In accordance with aspects of the present invention, a power converter comprises switches that alternately connect high and low voltages to an input to a reactive circuit. A control circuit controls cycling of the switches. The control circuit includes a burst mode in which the switches are cycled in a burst and then held off during a wait period responsive to a control signal. A compensation circuit modifies the control signal to reduce the number of switch cycles during a burst period. In particular, the burst may be reduced to a single switch cycle of the switches.

### BRIEF DESCRIPTION OF DRAWINGS

FIG. 1 illustrates a buck converter including a control IC having a transconductance error amplifier for feedback control during normal and burst-mode operation.

FIG. 2 presents wave-forms showing typical multi-pulse operation of the circuit of FIG. 1 during burst mode operation.

FIG. 3 illustrates a transconductance error amplifier circuit with time-variant offset in accordance with the present invention.

FIG. 4 presents a single pulse waveform resulting from the time-variant offset of FIG. 3.

FIG. 5 illustrates a further embodiment of the invention including improvements to the gate drive and the time-variant offset circuit.

FIG. 6 illustrates yet another embodiment of the invention implemented with additional transistors to reduce power consumption.

### DETAILED DESCRIPTION OF THE INVENTION

A detailed description of preferred embodiments of the invention follows.

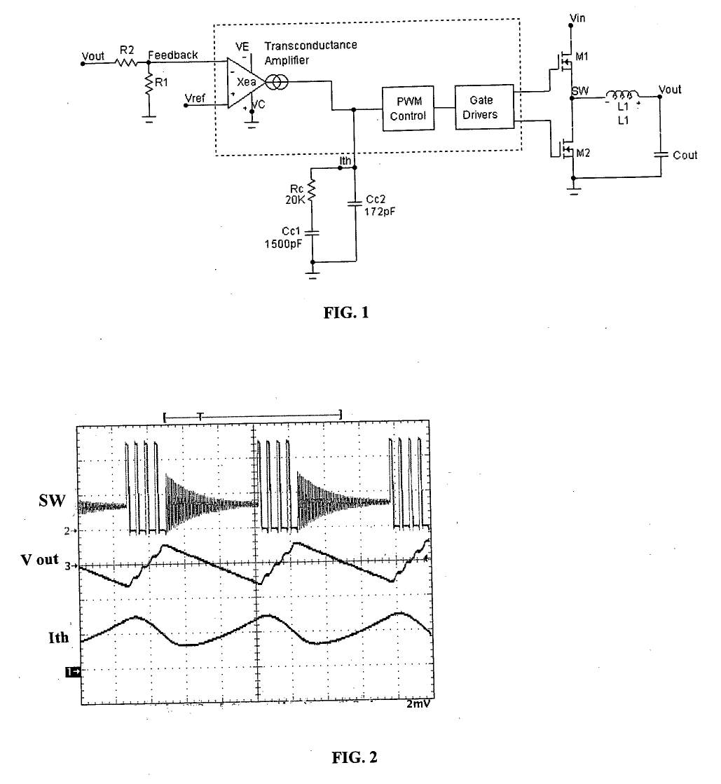

FIG. 1 illustrates a conventional buck converter circuit based on a control chip such as the LTC3770 chip provided by Linear Technology of San Jose, Calif. The MOSFET transistors M1 and M2 are alternately switched to connect an input node SW to a high voltage VIN and a low voltage ground. The input is to a reactive circuit including an inductor L1 and capacitor Cout. The gates of transistors M1 and M2 are driven by a controller IC such as an LTC3770 controller or an LTC3778 controller. The control chip, shown in broken lines, includes a PWM controller and gate drivers for the MOSFETs M1 and M2. The controller operates continuously at a varying frequency depending on the load conditions or, at light loads, operates in a burst mode. A control element within the chip, utilized with the present invention, is the XEA transconductance error amplifier.

FIG. 1 shows a simplified block diagram of a switch-mode DC-to-DC power converter using the LTC3770, a control I.C. manufactured by Linear Technology of San Jose, Calif. This diagram includes the external MOSFETs M1 and M2, which are driven by the control chip and make up the switching cell of the buck converter. Additional circuitry not shown implements current sensing and feedback, voltage margining, additional compensation or scaling of the output voltage sensing, and other features or required inputs to the control IC. The error amplifier circuit shown in FIG. 1 compares the scaled-down output voltage (from the resistor divider consisting of R2 and R1) with a reference voltage and generates the Ith signal as an input to the PWM control circuitry of the I.C. Since this is a transconductance amplifier, the gain and dynamics of the amplifier depend on the impedance of the compensation network between its output voltage, labeled Ith, and ground, which here consists of Rc, Cc1 and Cc2. Due to the polarity of the input connections of the transconductance amplifier Xea, the Ith voltage falls when the scaled output voltage is larger than the reference and rises when it is smaller than the reference.

The LTC3770 control I.C employs a current-mode controller and senses the current in the synchronous MOSFET M2. After holding a fixed on-time for high-side MOSFET M1, the controller turns on the synchronous rectifier MOSFET M2 and keeps it on until the inductor current falls down to a “valley” level determined by the Ith voltage. By controlling this valley level of the inductor current waveform, the I.C. sets the average inductor current needed to regulate the output voltage of the converter. The amount of ripple current in the inductor depends on the input and output voltages and the on-time, which is resistor-programmed by the user based on trade-offs among critical characteristics such as efficiency, physical inductor size, and output ripple voltage. The manufacturer of the I.C. recommends setting the on-time so that the inductor ripple current will be 40% of the rated full-load current.

At light loads, the peak inductor current would be much larger than the load current and would actually be negative for up to half of the switching cycle. This large current results in power dissipation in the MOSFET and the inductor, which may even be larger than the power delivered to the load. Some applications may be sensitive to the power dissipation at light load. This issue is addressed in the LTC3770 and other control circuits by providing an option for light-load discontinuous-mode (burst mode) operation, whereby the PWM controller terminates conduction of the low-side MOSFET M2 when the inductor current falls to zero, and then holds both MOSFETs off until the output voltage falls low enough for the Ith signal to rise above 0.8V, which is the level corresponding to a zero current valley. Since most of the power dissipation of the converter, even at light loads, is due to switching the MOSFETs each cycle and conducting current through the MOSFETs and the inductor, this dissipation is reduced approximately in proportion to the duty cycle of the period during which the chip is holding both switches off and waiting for the output voltage to fall. (This “waiting time” is not to be confused with the much shorter “dead time” used to ensure no cross-conduction between turning one MOSFET off and the other on.)

FIG. 2 shows waveforms associated with the discontinuous operating mode of the LTC3770. A high level on the SW signal (M2 drain, switched node, shown on channel 2) indicates high-side FET conduction and a zero voltage level indicates low-side FET conduction. Oscillatory or flat voltages in between these two levels indicate the waiting period in which both FETs are held off. It can be seen that even though the Ith signal on channel 1 begins to fall during the first cycle after the waiting period, the controller continues to drive the MOSFETs for one or more additional cycles until the Ith voltage falls below some threshold. The problem seems to be an apparent difference between the rising and falling thresholds of the Ith voltage associated with the decisions to initiate the first switching cycle while Ith rising, and to follow up with subsequent switching cycles while Ith is falling. This behavior may be caused by hysteresis, propagation delays, noise sensitivity, or some other aspect of the control chip design. Channel 3 shows the output voltage getting ratcheted up by each of these switching cycles, since the average inductor current during these cycles is much larger than the load current. The result is an undesirably large output voltage ripple.

The output voltage ripple associated with this discontinuous operating mode can be reduced by adding circuitry to the compensation network that forces the PWM controller to drive a single switching cycle at a time, or at least to drive fewer switching cycles in each burst. One way to accomplish this is by adding a time-variant offset voltage in series with the compensation network. The offset voltage is applied during the waiting period and removed during the first switching cycle. The offset voltage increases the Ith voltage above the rising threshold of the PWM controller, causing it to initiate a switching cycle sooner. Removing the offset voltage during the first switching cycle lowers the Ith voltage below the falling threshold, preventing the PWM controller from driving additional switching cycles. The reduction of energy transferred to the output during each burst results in lower output ripple voltage amplitude and a higher ripple frequency.

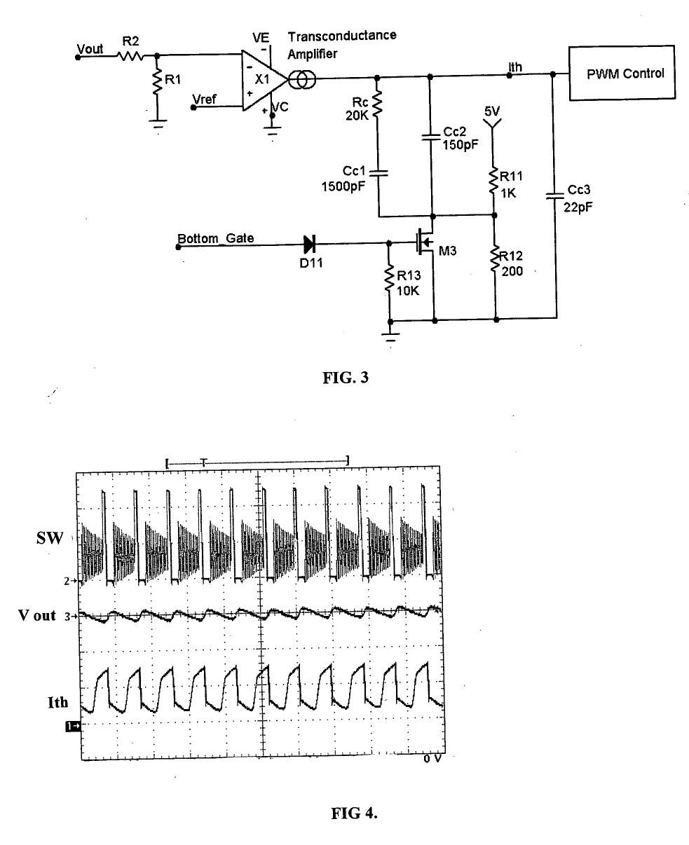

The circuit of FIG. 3 implements the time-variant offset voltage described above. An offset voltage is generated from an existing 5V supply through the resistive divider consisting of R11 and R12. MOSFET M3 is turned on through diode D11 to short out the offset voltage when the gate of the synchronous rectifier M2 goes high for the freewheeling portion of the switching cycle. Resistor R13 provides a path for the M3 gate voltage to discharge shortly after the PWM controller has terminated the first pulse and/or burst of pulses. Note that Cc2 has been reduced from 172 pF in FIG. 1 to 150 pF in FIG. 2, and Cc3 has been added to provide some modest noise filtering of the Ith voltage during periods when MOSFET M3 is off. The large ratio of Cc2 to Cc3 ensures that most of the instantaneous voltage shift at the drain of M3 appears on the Ith voltage as well. The sum of these two capacitors is equal to the original compensation capacitor Cc2, so that the circuit is unchanged during continuous conduction mode (at heavier loads) where the MOSFET remains on all the time.

FIG. 4 shows the waveforms resulting from the addition of the time variant offset circuit shown in FIG. 3. The conditions and oscilloscope settings are otherwise identical to those of FIG. 2. In this case it can be seen that the original circuit had bursts of 4 switching cycles spaced about 13 uS apart, whereas the improved circuit gives single pulses spaced apart by only about 4 uS. The error amplifier output voltage (Ith, channel 1) can be seen to instaneously drop about 0.5V when the synchronous MOSFET M2 turns on (M2 drain voltage goes to 0V in Channel 2). About 1 us later, the Ith voltage rises partially back up as the gate of MOSFET M3 is discharged. Due to the more even distribution of switching cycles, the peak-to-peak output voltage ripple is reduced by nearly a factor of 4 from 62 mV in FIG. 2 to 18 mV in FIG. 4.

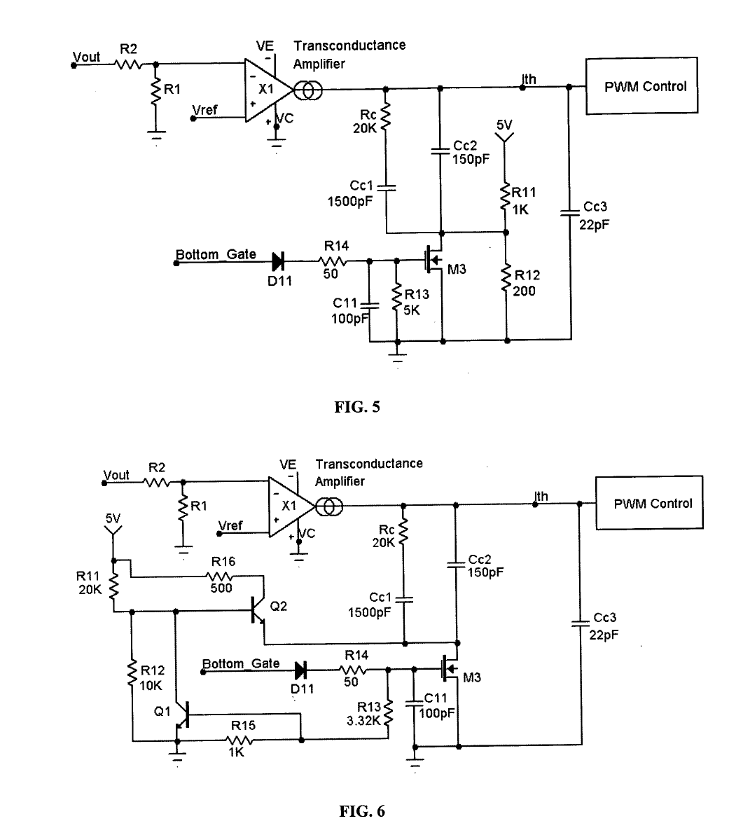

FIG. 5 illustrates some enhancements to the circuitry that drives the gate of MOSFET M3. R14 limits the gate current so as to reduce any impact on the switching speed of the main MOSFET M2 in case the gate charge drawn by M3 is a significant fraction of that drawn by M2. C11 may also be added as needed to reduce the dependence of the M3 gate voltage discharge time delay (time to discharge to M3 gate threshold voltage) on the gate capacitance value, which may have substantially more production variation than the capacitance of a discrete capacitor. Increasing the net capacitance of C11 and the M3 gate, however, requires a decrease in the value of R13 to maintain a given delay in the turn-off of M3. Since R13 loads the gate driver and bias supply, especially during continuous conduction operation, moderation must be exercised when using C11 to swamp out gate capacitance variation.

The gate voltage discharge time delay is typically set to be just a bit larger than the on-time of the high-side FET, so that M3 remains on continuously during normal (non-burst-mode) operation at heavier loads. In this case, the transconductance amplifier output sees only the compensation network consisting of Rc, Cc1, and Cc2.

With the offset voltage generation scheme of FIGS. 3 and 5, the loading on the internal supply might be considered unacceptable either due to heating of bias supply elements or the impact on no-load or light-load system power dissipation. The values of the resistors R11 and R12 are made low to provide a relatively low impedance offset voltage source which helps to charge capacitor Cc2 and raise the Ith voltage quickly when the MOSFET is turned off. An active circuit approach to the offset generation could provide a better compromise between the impedance and power consumption requirements. In FIG. 6, for example, Q2 is employed as an emitter follower with the offset voltage set by the R12/R11 resistive divider from the 5V bias supply, less the base-emitter voltage drop of Q2. With voltage divider R15/R13 driving the base of Q1 from the gate of M3, Q1 turns off Q2 at approximately the same time that M3 is turned on. Consequently, Q2 supplies only the current needed to drive the compensation network when M3 is off. In case of timing differences and threshold variation resulting in Q2 being on at the same time as M3, R16 limits the instantaneous Q2 collector current to a reasonable level.

While this invention has been particularly shown and described with references to preferred embodiments thereof, it will be understood by those skilled in the art that various changes in form and details may be made therein without departing from the scope of the invention encompassed by the appended claims.

What is claimed is:

1. A power converter comprising:
switches that alternately connect high and low voltages to an input to a reactive circuit;
a control circuit that controls cycling of the switches, the control circuit including a burst mode in which the switches are cycled in a burst and then held off during a wait period responsive to a control signal; and
a compensation circuit that modifies the control signal to reduce the number of switch cycles during a burst.

2. A power converter as claimed in claim 1, wherein the number of switch cycles is reduced to one cycle.

3. A power converter as claimed in claim 1, wherein -the compensation circuit adds a time-variant offset to the control signal.

4. A power converter as claimed in claim 3, wherein the time-variant offset is removed when the input is connected to the low voltage.

5. A power converter as claimed in claim 1, wherein the input is applied to an inductor of the reactive circuit.

6. A power converter as claimed in claim 1, wherein the control signal falls as the power converter output rises.

7. A method of providing a power conversion comprising:
alternately switching switches to connect an input to a reactor circuit to high and low voltages;
controlling cycling of the switches in a burst mode in which the switches are cycled in a burst and then held off during a wait period responsive to a control signal; and
modifying the control signal to reduce the number of switch cycles during a burst.

8. A method as claimed in claim 7, wherein the switch cycles are reduced to one cycle during the burst.

9. The method as claimed in claim 7, wherein the control signal is modified by a time-variant offset.

10. A method as claimed in claim 9, wherein the offset is removed when the input is connected to a low voltage.

11. A method as claimed in claim 7, wherein the input is applied to an inductor of the reactive circuit.

12. A method as claimed in claim 7, wherein the control signal falls as -the output of the power converter rises.

13. A power converter comprising:
switches that alternately connect an input to a reactive circuit to high and low voltages;
a control circuit that controls cycling of the switches, the control circuit including a burst mode in which the switches are cycled in a burst and then held off during a wait period responsive to a control signal; and
compensation circuit means for modifying the control signal to reduce the number of switch cycles during a burst.
